(19) United States
(12) Patent Application Publication
(10) Pub. No.: US 2026/0340233 A1
(43) Pub. Date: Oct. 29, 2026

(54) METHOD AND SYSTEM FOR GROUTING SIMULATION AND PRE-CONTROL DECISION-MAKING BASED ON CROSS-SCALE DATA FEDERATION

(71) Applicant: SHANDONG UNIVERSITY, Jinan (CN)

(72) Inventors: Dongdong PAN, Jinan (CN); Shengzhe ZHAO, Jinan (CN); Yihui LI, Jinan (CN); Dandan WU, Jinan (CN); Zhiyang WANG, Jinan (CN); Miao ZHANG, Jinan (CN); Qiang LI, Jinan (CN); Zhenhao XU, Jinan (CN)

(21) Appl. No.: 19/435,933

(22) Filed: Dec. 30, 2025

(30) Foreign Application Priority Data
Jan. 14, 2025 (CN) 2025100581737

(51) Int. Cl. G06F 30/27; G06F 111/10

(52) U.S. Cl. CPC G06F 30/27; G06F 2111/10

(57) ABSTRACT

A method for grouting simulation and pre-control decision-making based on cross-scale data federation includes: constructing a knowledge graph based on grouting test data and simulation data of laboratory grouting tests, and corresponding working condition data; training a graph convolutional neural network using node and edge information of the knowledge graph as input values, and known grouting parameters as output values, to obtain a trained graph convolutional neural network; constructing a geological attribute model of a target tunnel based on target tunnel's geological conditions; obtaining engineering construction monitoring data of target tunnel; performing spatiotemporal alignment between the engineering construction monitoring data and the geological attribute model; inputting aligned data into the trained graph convolutional neural network to obtain grouting prediction data; and, adjusting a grouting scheme according to the grouting prediction data until grouting construction is completed.

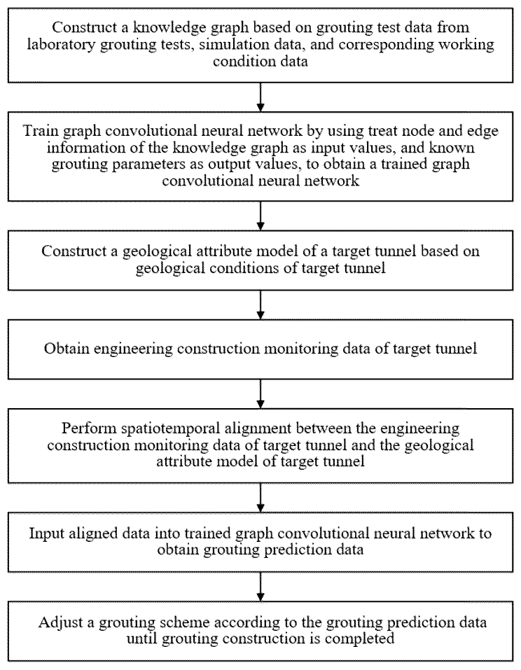

### CROSS-REFERENCE TO RELATED APPLICATIONS

The present invention claims priority benefits to Chinese Patent Application No. 202510058173.7, filed with the China National Intellectual Property Administration on Jan. 14, 2025 and entitled “Method and System for Grouting Simulation and Pre-Control Decision-Making Based on Cross-Scale Data Federation”, the entire contents of which are incorporated herein by reference herein and constitute a part of the present invention for all purposes.

### TECHNICAL FIELD

The present invention relates to the field of geotechnical engineering technology, and in particular to a method and system for grouting simulation and pre-control decision-making based on cross-scale data federation.

### BACKGROUND

As an important constituent of modern urban infrastructure construction, tunnel transportation has been widely applied in various transportation projects such as railways, highways, and subways. With the acceleration of urbanization, the scale of tunnel construction is expanding rapidly, making the safety and stability of tunnel structures a core concern in the engineering field. Especially under extreme geological conditions, tunnel excavation faces complex geological formations and risks of sudden geological hazards, demanding more precise and efficient application of grouting reinforcement technology in tunnel construction. Therefore, how to optimize the grouting process and improve the precision of grout diffusion and the effect of grouting reinforcement has become a key technical challenge in tunnel construction.

Digital twin technology is an innovative technology that connects physical entities with digital models to monitor and simulate physical processes in real time. In tunnel construction, digital twins can help fully understand the actual operational state of the tunnel, accurately predict the impact of the geological environment on the grouting process, and improve the reasonableness and accuracy of the grouting reinforcement process. Although the digital twin technology has broad application potential in tunnel engineering, its practical application in tunnel grouting processes still faces some challenges. Especially in the high-risk area of the tunnel face, there are many uncertainties such as geological heterogeneity, groundwater influence, and grout flow paths. These factors pose a significant challenge to the real-time monitoring and dynamic adjustment of digital twin models.

### SUMMARY

To address the deficiencies of the existing technology, the present invention provides a method and system for grouting simulation and pre-control decision-making based on cross-scale data federation.

According to an aspect, a method for grouting simulation and pre-control decision-making based on cross-scale data federation is provided, including:
constructing a knowledge graph based on grouting test data and simulation data of laboratory grouting tests, and corresponding working condition data, and training the graph convolutional neural network using node and edge information of the knowledge graph as input values of the graph convolutional neural network and using known grouting parameters as output values of the graph convolutional neural network to obtain a trained graph convolutional neural network;
constructing a geological attribute model of a target tunnel based on geological conditions of the target tunnel; and

obtaining engineering construction monitoring data of the target tunnel, performing spatiotemporal alignment between the engineering construction monitoring data of the target tunnel and the geological attribute model of the target tunnel, inputting the aligned data into the trained graph convolutional neural network to obtain grouting prediction data, and adjusting a grouting scheme according to the grouting prediction data until grouting construction is completed.

According to another aspect, a system for grouting simulation and pre-control decision-making based on cross-scale data federation is provided, including:
a training module, configured to: construct a knowledge graph based on grouting test data and simulation data of laboratory grouting tests, and corresponding working condition data, and train the graph convolutional neural network using node and edge information of the knowledge graph as input values of the graph convolutional neural network and using known grouting parameters as output values of the graph convolutional neural network to obtain a trained graph convolutional neural network;
a construction module, configured to: construct a geological attribute model of a target tunnel based on geological conditions of the target tunnel; and
a prediction module, configured to: obtain engineering construction monitoring data of the target tunnel, perform spatiotemporal alignment between the engineering construction monitoring data of the target tunnel and the geological attribute model of the target tunnel, input the aligned data into the trained graph convolutional neural network to obtain grouting prediction data, and adjust a grouting scheme according to the grouting prediction data until grouting construction is completed.

The foregoing technical solutions have the following advantages or beneficial effects:
according to the present invention, constructing a knowledge graph based on grouting test data and simulation data of laboratory grouting tests, and corresponding working condition data, and training the graph convolutional neural network using node and edge information of the knowledge graph as input values of the graph convolutional neural network and using known grouting parameters as output values of the graph convolutional neural network to obtain a trained graph convolutional neural network; in the present invention, the training of the graph convolutional neural network using laboratory grouting data is realized, thus providing a foundation for cross-scale grouting process modeling;
according to the present invention, obtaining engineering construction monitoring data of the target tunnel, performing spatiotemporal alignment between the engineering construction monitoring data of the target tunnel and the geological attribute model of the target tunnel, inputting the aligned data into the trained graph convolutional neural network to obtain grouting prediction data, and adjusting a grouting scheme according to the grouting prediction data until grouting construction is completed; in the present invention, the spatiotemporal alignment of data and cross-scale grouting pre-control analysis using the trained graph convolutional neural network is realized.

### BRIEF DESCRIPTION OF THE DRAWINGS

The accompanying drawings constituting a part of the present invention are used to provide further understanding of the present invention. The exemplary examples of the present invention and descriptions thereof are used to explain the present invention, and do not constitute improper limitation of the present invention.

The FIGURE is a flowchart of a method according to Example 1.

### DETAILED DESCRIPTION

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used here are only for describing specific examples and are not intended to limit exemplary examples according to the present invention. The terms “include/including”, “comprise/comprising”, as well as any variations thereof, are intended to cover a non-exclusive inclusions, such as processes, methods, systems, products, or devices that contain a series of steps or units that are not necessarily limited to those steps or units clearly listed, but may include other steps or units that are not clearly listed or inherent to these processes, methods, products, or devices.

### Example 1

The present example provides a method for grouting simulation and pre-control decision-making based on cross-scale data federation.

As shown in the FIGURE, the method for grouting simulation and pre-control decision-making based on cross-scale data federation includes:

S101: constructing a knowledge graph based on grouting test data and simulation data of laboratory grouting tests, and corresponding working condition data, and training a graph convolutional neural network using node and edge information of the knowledge graph as input values of the graph convolutional neural network and using known grouting parameters as output values of the graph convolutional neural network to obtain a trained graph convolutional neural network.

S102: constructing a geological attribute model of a target tunnel based on geological conditions of the target tunnel.

S103: obtaining engineering construction monitoring data of the target tunnel, performing spatiotemporal alignment between the engineering construction monitoring data of the target tunnel and the geological attribute model of the target tunnel, inputting the aligned data into the trained graph convolutional neural network to obtain grouting prediction data, and adjusting a grouting scheme according to the grouting prediction data until grouting construction is completed.

Further, the constructing the knowledge graph based on grouting test data and simulation data of laboratory grouting tests, and corresponding working condition data in S101 includes:

(1-1): Obtaining the grouting test data of the laboratory grouting tests, the simulation data, and the corresponding working condition data, and standardize all obtained parameters.

(1-2): Calculating a covariance matrix between the parameters, and calculating eigenvalues and eigenvectors of the covariance matrix.

(1-3): Sorting all the eigenvalues in descending order, selecting the eigenvectors corresponding to the top k eigenvalues as principal components, and calculating a principal component score matrix based on the principal components.

(1-4): Defining both original parameters and the principal components as nodes of the knowledge graph, calculating correlation coefficients between the nodes, and if the correlation coefficients are greater than a set threshold, determining that a connecting edge is provided between the nodes, or otherwise, determining that no connecting edge is present between the nodes, wherein the correlation coefficients between the nodes include: correlation coefficients between original parameter nodes and correlation coefficients between principal component nodes.

(1-5): Calculating a factor loading matrix between the original parameter nodes and the principal component nodes, and determining, if a factor loading value of an original parameter node on a principal component node is greater than a set threshold, that a connecting edge is provided between the original parameter node and the principal component node, wherein a weight of the connecting edge is an absolute value of the factor loading value.

(1-6): Supplementing attributes of the original parameter nodes, and supplementing attributes of the principal component nodes, to obtain the knowledge graph.

Further, the obtaining the grouting test data and simulation data of laboratory grouting tests, and the corresponding working condition data in (1-1) includes:
extracting data and parameters separately from grouting test data and simulation data (grouting pressure, grouting flow rate, grouting velocity, grout mix ratio, etc.) of the laboratory grouting tests for various media (including but not limited to porous media, fractured media, and pipeline media), and corresponding working condition designs (fractured media: fracture size, filling medium type, flowing water conditions, etc.; pipeline media: pipeline size, filling medium type, flowing water conditions, etc.; porous media: flowing water conditions, water storage capacity, porosity, permeability coefficient, in-situ stress conditions, etc.).

Further, the standardize all obtained parameters in (1-1) includes:
standardizing grouting parameter variable data:

$${Z}_{ij} = \frac{{X}_{ij} - {μ}_{j}}{{σ}_{j}} ;$$

wherein, Zᵢⱼ represents a value of an i^{th} sample on a j^{th} feature after standardization, Xᵢⱼ represents original data, μⱼ represents a mean of the j^{th} feature, and σⱼ represents a standard deviation of the j^{th} feature.

Further, the calculating a covariance matrix between the parameters in (1-2) includes:
calculating the covariance matrix between the parameters:

$$C = \frac{1}{n - 1} {\sum }_{i = 1}^{n} ( {Z}_{i} - \overline{Z} ) {( {Z}_{i} - \overline{Z} )}^{T} ;$$

wherein, C is the covariance matrix, Zᵢ is the i^{th} sample, and Z̅ is a mean vector of the sample.

Further, the calculating eigenvalues and eigenvectors of the covariance matrix in (1-2) includes:
calculating the eigenvalues and the eigenvectors of the covariance matrix, and performing eigenvalue decomposition on the covariance matrix:

Cvⱼ=λⱼvⱼ;
wherein, λⱼ represents a j^{th} eigenvalue, and vⱼ represents a j^{th} eigenvector.

Further, the sorting all the eigenvalues in descending order and selecting the eigenvectors corresponding to the top k eigenvalues as principal components in (1-3) includes:
sorting all the eigenvalues in descending order, and adjusting the order of the eigenvectors accordingly, where after the sorting, a larger eigenvalue indicates more data variance explained by the corresponding principal component, and the sorted eigenvalues and eigenvectors satisfy:

λ₁≥λ₂≥ . . . ≥λₚ;
wherein, λ₁, λ₂, . . . , λₚ are the eigenvalues sorted in descending order, and the corresponding eigenvectors are v₁, v₂, . . . , vₚ; and
selecting the top k principal components are selected according to the magnitude of the eigenvalues, and selecting the eigenvectors that satisfy the following condition:

Vₖ=[v₁,v₂, . . . ,vₖ];
wherein, Vₖ is a matrix composed of the top k eigenvectors.

Further, the calculating a principal component score matrix based on the principal components in (1-3) includes:
calculating principal component scores:

T=Z·Vₖ;
wherein, T is the principal component score matrix, Z is a standardized data matrix, and Vₖ is a matrix composed of the top k eigenvectors; and
defining nodes and edges, defining each original parameter physical quantity and the principal components as nodes, and constructing edges between original variables and edges between the principal components and the original variables.

Further, the calculating correlation coefficients between original parameter nodes in (1-4) includes:
calculating correlation coefficients between the original variables:

$${ρ}_{ij} = \frac{cov ( {X}_{i} , {X}_{j} )}{{σ}_{i} {σ}_{j}} ;$$

wherein, ρᵢⱼ is a Pearson correlation coefficient between two variables Xᵢ and Xⱼ, cov(Xᵢ, Xⱼ) is a covariance between two variables Xᵢ and Xⱼ, and σᵢ and σⱼ are standard deviations of the two variables Xᵢ and Xⱼ.

Further, the calculating correlation coefficients between principal component nodes in (1-4) includes:
calculating the correlation coefficients between the principal components:

$${ρ}_{{PC}_{i} , {PC}_{j}} = \frac{cov ( {PC}_{i} , {PC}_{j} )}{{σ}_{{PC}_{i}} {σ}_{{PC}_{j}}} ;$$

wherein, ρ_{PC}_{ᵢ}_{,PC}_{ⱼ} is a correlation coefficient between two principal components PCᵢ and PCⱼ; and
defining a variable correlation threshold; if ρᵢⱼ is greater than a threshold, determining that the correlation between two variables is strong; if ρᵢⱼ is less than the threshold, determining that the correlation between the two variables is weak; for the two variables with strong correlation, determining the correlation coefficient as a weight value of an edge; and if the correlation coefficient ρᵢⱼ between two variables is less than a set minimum value, not defining the edge. Thus, the definition of edges between the original variables and between pairwise variables of the principal components is realized.

Further, the calculating a factor loading matrix between the original parameter nodes and the principal component nodes, and determining, if a factor loading value of an original parameter node on a principal component node is greater than a set threshold, that a connecting edge is provided between the original parameter node and the principal component node, where a weight of the connecting edge is an absolute value of the factor loading value, in (1-5) includes:
defining edges between the principal components and original variables, and calculating the factor loading matrix:

L=[v₁,v₂, . . . ,vₖ];
wherein, L is the factor loading matrix, and vᵢ is an eigenvector of an i^{th} principal component.

If the factor loading value of an original variable on the principal component is greater than a set threshold, it is determined that the original variable has a strong contribution to the principal component, and a weight of an edge between the original variable and the principal component is an absolute value of loading.

Further, the supplementing attributes of the original parameter nodes and supplement attributes of the principal component nodes to obtain the knowledge graph in (1-6) includes:
supplementing basic attributes (variable name, physical unit, etc.), statistical attributes (variable mean, standard deviation, grouting initial value, maximum and minimum values, variance, skewness, etc.), variables derived from background information (laboratory monitoring data, simulation, sensor type, and environmental conditions), and physical attributes (permeability, porosity, in-situ stress, etc.) of each original variable node; and
supplementing basic attributes (principal component name), calculation attributes (factor loading value of the principal component and principal direction of the principal component), and statistical attributes (mean of the principal component and standard deviation of the principal component) of each principal component node.

It should be understood that the node and edge information in the established graph is used as input features of the graph convolutional neural network. Through graph convolution reasoning, grouting effects under different grouting conditions and geological formations may be inferred according to existing experimental data and simulation data.

Further, in the operation of training the graph convolutional neural network using node and edge information of the knowledge graph as input values of the graph convolutional neural network and using known grouting parameters as output values of the graph convolutional neural network to obtain a trained graph convolutional neural network, the following loss function is used:

Lₜₒₜₐₗ=α₁·L_{prediction}+α₂·L_{regularization}+α₃·L_{robustness};
wherein, α₁, α₂, α₃ are hyper-parameters balancing weights of respective losses.

An expression of L_{prediction} is:

$${L}_{prediction} = \frac{1}{N} {\sum }_{i = 1}^{N} {ω}_{i} \cdot ( {{\hat{y}}_{i} - {y}_{i} )}^{2} ;$$

$${ω}_{i} = \frac{exp ( β \cdot \vert {y}_{i} - \overline{y} \vert )}{{\sum }_{j = 1}^{N} exp ( β \cdot \vert {y}_{j} - \overline{y} \vert )} ;$$

wherein, L_{prediction} represents a prediction error loss for measuring an error between a predicted value ŷᵢ and a true value yᵢ; a dynamic weight ωᵢ is used for enhancing attention to high-deviation samples; β represents a dynamic adjustment parameter for controlling the influence degree of outliers; y̅ represents a mean of a dataset, and the purpose of using the prediction error loss is to dynamically adjust the attention to different samples and enhance the prediction ability for high-deviation areas.

Further, a formula expression of L_{regularization} is:

$${L}_{regularization} = {λ}_{1} \cdot {\sum }_{i = 1}^{4} {w}_{i}^{2} + {λ}_{2} \cdot {\sum }_{i = 1}^{4} {( {w}_{i} - \frac{1}{4} )}^{2} ;$$

wherein, λ₁ is used for controlling the magnitude of the weight to prevent overfitting, λ₂ is used for controlling the balance of the weight to encourage uniform distribution, and the purpose of using a weight regularization loss function is to avoid overfitting and unbalanced distribution caused by an excessively large weight.

A specific expression of L_{robustness} is:

$${L}_{robustness} = \frac{1}{N} {\sum }_{i = 1}^{N} ϕ ( {\hat{y}}_{i} - {y}_{i} ) ;$$

$$ϕ ( z ) = \{ \begin{matrix}\frac{1}{2} {z}^{2} , & if \vert z \vert \leq δ \\ δ \cdot ( \vert z \vert - \frac{1}{2} δ ) , & if \vert z \vert > δ\end{matrix} ;$$

wherein, δ represents an outlier threshold to control the penalty degree for an excessively large error; L_{robustness} represents a robustness loss function for enhancing robustness of the model to outliers; φ(z) represents a kernel function of the loss function for handling an error between a predicted value and a true value of the model; z represents a difference (error) between the predicted value and the true value; and N represents a total number of data samples.

Further, the constructing a geological attribute model of a target tunnel based on geological conditions of the target tunnel in S102 includes:
obtaining spatial information and geological attribute information of a geological body area of the target tunnel, dividing the geological body area of the target tunnel into several grids, and constructing a grid model, where the geological attribute information includes: elastic modulus, water seepage information, porosity, fracture position, and distribution; and
performing, for each grid area, data preprocessing on the obtained geological attribute data, and assigning geological attributes to the grid model according to the preprocessed data, to obtain the geological attribute model of the target tunnel,

The preprocessing includes: refining a grid size:

$$Δ x = \frac{L}{{N}^{′}}$$

wherein Δx is the size of the grid, L is the length of a tunnel area, and N is the number of nodes of the grid.

Further, before the obtaining engineering construction monitoring data of the target tunnel and performing spatiotemporal alignment between the engineering construction monitoring data of the target tunnel and the geological attribute model of the target tunnel in S103, the method further includes data standardization processing. The data standardization processing specifically includes:
performing data standardization processing on the engineering construction monitoring data:

$${Z}_{ij} = \frac{{X}_{ij} - {μ}_{j}}{{σ}_{j}} ;$$

wherein, Zᵢⱼ represents a j^{th} eigenvalue of an i^{th} sample after standardization, Xᵢⱼ represents original data, μⱼ represents a mean of a j^{th} feature, and σⱼ represents a standard deviation of the j^{th} feature.

Further, in the operation of obtaining engineering construction monitoring data of the target tunnel and performing spatiotemporal alignment between the engineering construction monitoring data of the target tunnel and the geological attribute model of the target tunnel in S103, the spatiotemporal alignment includes temporal alignment and spatial alignment. The temporal alignment includes:
first, interpolating, for two data points (t₁, y₁) and (t₂, y₂), data at different time steps by temporal interpolation to the same time interval using a spline interpolation method, the spline interpolation adopting the following formula:

S(t)=a(t−t₁)³+b(t−t₁)²+c(t−t₁)+d;
wherein, a, b, c, and d are polynomial coefficients, which are determined according to continuity of values, derivatives, and second derivatives of adjacent data points.

Further, the spatial alignment includes:
determining data points of experimental or simulation data (all containing the spatial position (xᵢ, yᵢ)) and corresponding values (zᵢ) as:
   (x₁, y₁, z₁), (x₂, y₂, z₂), . . . , (xₙ, yₙ, zₙ);
calculating a distance dᵢ between a target point and a known data point:

dᵢ=\sqrt{(x₀−xᵢ)²+(y₀−yᵢ)²};
wherein, x₀, y₀ represents coordinates of the target point, and xᵢ, yᵢ represents coordinates of the known point i;
calculating a weight of each known data point using an inverse distance weighting method, a weight wᵢ being inversely proportional to a distance d(x, xᵢ) between a target point x and a data point (xᵢ, yᵢ):

$${w}_{i} = \frac{1}{{d}_{i}^{p}} ;$$

wherein, wᵢ represents the weight of the known point i to the target point, and p represents a weight exponent, which is typically 2;
calculating an estimated value z₀ of the target point (x₀, y₀) by weighted averaging:

$${z}_{0} = \frac{{\sum }_{i = 1}^{n} {w}_{i} {z}_{i}}{{\sum }_{i = 1}^{n} {w}_{i}} ;$$

wherein, z₀ represents the estimated value of the target point (x₀, y₀), wᵢ represents the weight of the known point i, and zᵢ represents a data value of the known point i; and
realizing the alignment of the entire spatial data according to the estimated value z₀ of an interpolation result.

The aligned data is input into the graph convolutional neural network. Based on the phased real-time predicted flowing water flow field, grouting pressure field, velocity field, and grout diffusion range, real-time adjustments are made to grouting device parameters and grouting schemes. The cyclic adjustment process is continued until the grouting construction is completed, so as to realize the pre-control analysis and decision-making for the entire process of grouting construction.

### Example 2

The present example provides a system for grouting simulation and pre-control decision-making based on cross-scale data federation.

The system for grouting simulation and pre-control decision-making based on cross-scale data federation includes:
a training module, configured to: construct a knowledge graph based on grouting test data and simulation data of laboratory grouting tests, and corresponding working condition data, and train the graph convolutional neural network using node and edge information of the knowledge graph as input values of the graph convolutional neural network and using known grouting parameters as output values of the graph convolutional neural network to obtain a trained graph convolutional neural network;
a construction module, configured to: construct a geological attribute model of a target tunnel based on geological conditions of the target tunnel; and
a prediction module, configured to: obtain engineering construction monitoring data of the target tunnel, perform spatiotemporal alignment between the engineering construction monitoring data of the target tunnel and the geological attribute model of the target tunnel, input the aligned data into the trained graph convolutional neural network to obtain grouting prediction data, and adjust a grouting scheme according to the grouting prediction data until grouting construction is completed.

The foregoing descriptions are merely preferred embodiments of the present invention, but are not intended to limit the present invention. A person skilled in the art may make various alterations and variations to the present invention. Any modification, equivalent replacement, or improvement made within the spirit and principle of the present invention shall fall within the protection scope of the present invention.

1. A method for grouting simulation and pre-control decision-making based on cross-scale data federation, comprising:
constructing a knowledge graph based on grouting test data and simulation data of laboratory grouting tests, and corresponding working condition data, and training the graph convolutional neural network using node and edge information of the knowledge graph as input values of the graph convolutional neural network and using known grouting parameters as output values of the graph convolutional neural network to obtain a trained graph convolutional neural network;
constructing a geological attribute model of a target tunnel based on geological conditions of the target tunnel; and
obtaining engineering construction monitoring data of the target tunnel, performing spatiotemporal alignment between the engineering construction monitoring data of the target tunnel and the geological attribute model of the target tunnel, inputting the aligned data into the trained graph convolutional neural network to obtain grouting prediction data, and adjusting a grouting scheme according to the grouting prediction data until grouting construction is completed;
wherein:
constructing the knowledge graph based on the grouting test data and simulation data of the laboratory grouting tests, and corresponding working condition data comprises:
obtaining the grouting test data of the laboratory grouting tests, the simulation data, and the corresponding working condition data, and standardizing all obtained parameters;
calculating a covariance matrix between the parameters, and calculating eigenvalues and eigenvectors of the covariance matrix;
sorting all the eigenvalues in descending order, selecting the eigenvectors corresponding to the top k eigenvalues as principal components, and calculating a principal component score matrix based on the principal components;
defining both original parameters and the principal components as nodes of the knowledge graph, calculating correlation coefficients between the nodes, and if the correlation coefficients are greater than a set threshold, determining that a connecting edge is provided between the nodes; otherwise, determining that no connecting edge is present between the nodes; wherein the correlation coefficients between the nodes comprise: correlation coefficients between original parameter nodes and correlation coefficients between principal component nodes;
calculating a factor loading matrix between the original parameter nodes and the principal component nodes, and determining, if a factor loading value of an original parameter node on a principal component node is greater than a set threshold, that a connecting edge is provided between the original parameter node and the principal component node, wherein a weight of the connecting edge is an absolute value of the factor loading value; and
supplementing attributes of the original parameter nodes, and supplementing attributes of the principal component nodes, to obtain the knowledge graph.

2. The method for grouting simulation and pre-control decision-making based on cross-scale data federation according to claim 1, wherein the standardizing all obtained parameters comprises:
standardizing grouting parameter variable data:
$${Z}_{i j} = \frac{{X}_{i j} - {μ}_{j}}{{σ}_{j}} ;$$
wherein, Zᵢⱼ represents a value of an i^{th} sample on a j^{th} feature after standardization, Xᵢⱼ represents original data, μⱼ represents a mean of the j^{th} feature, and σⱼ represents a standard deviation of the j^{th} feature;
the calculating a covariance matrix between the parameters comprises:
calculating the covariance matrix between the parameters:
$$C = \frac{1}{n - 1} {\sum }_{i = 1}^{n} ( {Z}_{i} - \overline{Z} ) {( {Z}_{i} - \overline{Z} )}^{T} ;$$
wherein, C is the covariance matrix, Zᵢ is the i^{th} sample, and Z̅ is a mean vector of the sample;
the calculating eigenvalues and eigenvectors of the covariance matrix comprises:
calculating the eigenvalues and the eigenvectors of the covariance matrix, and performing eigenvalue decomposition on the covariance matrix:
Cvⱼ=λⱼvⱼ;
wherein, λⱼ represents a j^{th} eigenvalue, and vⱼ represents a j^{th} eigenvector; and
the sorting all the eigenvalues in descending order and selecting the eigenvectors corresponding to the top k eigenvalues as principal components comprises:
sorting all the eigenvalues in descending order, and adjusting the order of the eigenvectors accordingly, wherein after the sorting, a larger eigenvalue indicates more data variance explained by the corresponding principal component, and the sorted eigenvalues and eigenvectors satisfy:
λ₁≥λ₂≥ . . . ≥λₚ;
wherein, λ₁≥λ₂≥ . . . ≥λₚ are the eigenvalues sorted in descending order, and the corresponding eigenvectors are v₁, v₂, . . . , vₚ; and
selecting the top k principal components according to the magnitude of the eigenvalues, and selecting the eigenvectors that satisfy the following condition:
Vₖ=[v₁,v₂, . . . ,vₖ];
wherein, Vₖ is a matrix composed of the top k eigenvectors.

3. The method for grouting simulation and pre-control decision-making based on cross-scale data federation according to claim 1, wherein the calculating a principal component score matrix based on the principal components comprises:
calculating principal component scores:
T=Z·Vₖ;
wherein, T is the principal component score matrix, Z is a standardized data matrix, and Vₖ is a matrix composed of the top k eigenvectors; and
defining nodes and edges, defining each original parameter physical quantity and the principal components as nodes, and constructing edges between original variables and edges between the principal components and the original variables;
the calculating correlation coefficients between original parameter nodes comprises:
calculating correlation coefficients between the original variables:
$${ρ}_{i j} = \frac{cov ( {X}_{i} , {X}_{j} )}{{σ}_{i} {σ}_{j}} ;$$
wherein, ρᵢⱼ is a Pearson correlation coefficient between two variables Xᵢ and Xⱼ, cov(Xᵢ, Xⱼ) is a covariance between the two variables Xᵢ and Xⱼ, and σᵢ and σⱼ are standard deviations of the two variables Xᵢ and Xⱼ; and
the calculating correlation coefficients between principal component nodes comprises:
calculating the correlation coefficients between the principal components:
$${ρ}_{{PC}_{i} , {PC}_{j}} = \frac{c o v ( P {C}_{i} , {PC}_{j} )}{{σ}_{P {C}_{i}} {σ}_{P {C}_{j}}} ;$$
wherein, ρ_{PC}_{ᵢ}_{,PC}_{ⱼ} is a correlation coefficient between two principal components PCᵢ and PCⱼ; and
defining a variable correlation threshold; if ρᵢⱼ is greater than a threshold, determining that the correlation between two variables is strong; if ρᵢⱼ is less than the threshold, determining that the correlation between the two variables is weak; for the two variables with strong correlation, determining the correlation coefficient as a weight value of an edge; and if the correlation coefficient ρᵢⱼ between two variables is less than a set minimum value, not defining the edge.

4. The method for grouting simulation and pre-control decision-making based on cross-scale data federation according to claim 1, wherein the calculating a factor loading matrix between the original parameter nodes and the principal component nodes, and determining, if a factor loading value of an original parameter node on a principal component node is greater than a set threshold, that a connecting edge is provided between the original parameter node and the principal component node, wherein a weight of the connecting edge is an absolute value of the factor loading value, comprises:
defining edges between the principal components and original variables, and calculating the factor loading matrix:
L=[v₁,v₂, . . . ,vₖ];
wherein, L is the factor loading matrix, and vᵢ is an eigenvector of an i^{th} principal component; and
the supplementing attributes of the original parameter nodes and supplementing attributes of the principal component nodes to obtain the knowledge graph comprises:
supplementing basic attributes, statistical attributes, variables derived from background information, and physical attributes of each original variable node; and, supplementing basic attributes, calculation attributes, and statistical attributes of each principal component node.

5. The method for grouting simulation and pre-control decision-making based on cross-scale data federation according to claim 1, wherein in the operation of training the graph convolutional neural network using node and edge information of the knowledge graph as input values of the graph convolutional neural network and using known grouting parameters as output values of the graph convolutional neural network to obtain a trained graph convolutional neural network, the following loss function is used:
Lₜₒₜₐₗ=α₁·L_{prediction}+α₂·L_{regularization}+α₃·L_{robustness};
wherein, L_{prediction} represents a prediction error loss function, L_{regularization} represents a weight regularization loss function, L_{robustness} represents a robustness loss function, and α₁, α₂, α₃ are hyper-parameters for balancing weights of respective losses.

6. The method for grouting simulation and pre-control decision-making based on cross-scale data federation according to claim 1, wherein the constructing a geological attribute model of a target tunnel based on geological conditions of the target tunnel comprises:
obtaining spatial information and geological attribute information of a geological body area of the target tunnel, dividing the geological body area of the target tunnel into several grids, and constructing a grid model, wherein the geological attribute information comprises: elastic modulus, water seepage information, porosity, fracture position, and distribution; and
performing, for each grid area, data preprocessing on the obtained geological attribute data, and assigning geological attributes to the grid model according to the preprocessed data, to obtain the geological attribute model of the target tunnel,
wherein the preprocessing comprises: refining a grid size:
$$Δ x = \frac{L}{N} ;$$
wherein, Δx is the size of the grid, L is the length of a tunnel area, and N is the number of nodes of the grid.

7. The method for grouting simulation and pre-control decision-making based on cross-scale data federation according to claim 1, wherein before the obtaining engineering construction monitoring data of the target tunnel and performing spatiotemporal alignment between the engineering construction monitoring data of the target tunnel and the geological attribute model of the target tunnel, the method further comprises data standardization processing, the data standardization processing specifically comprising:
performing data standardization processing on the engineering construction monitoring data:
$${Z}_{ij} = \frac{{X}_{i j} - {μ}_{j}}{{σ}_{j}} ;$$
wherein, Zᵢⱼ represents a j^{th} eigenvalue of an i^{th} sample after standardization, Xᵢⱼ represents original data, μⱼ represents a mean of a j^{th} feature, and σⱼ represents a standard deviation of the j^{th} feature;
in the operation of obtaining engineering construction monitoring data of the target tunnel and performing spatiotemporal alignment between the engineering construction monitoring data of the target tunnel and the geological attribute model of the target tunnel, the spatiotemporal alignment comprises temporal alignment and spatial alignment, the temporal alignment comprising:
first, interpolating, for two data points (t₁, y₁) and (t₂, y₂), data at different time steps by temporal interpolation to the same time interval using a spline interpolation method, the spline interpolation adopting the following formula:
S(t)=a(t−t₁)³+b(t−t₁)²+c(t−t₁)+d;
wherein, a, b, c, and d are polynomial coefficients, which are determined according to continuity of values, derivatives, and second derivatives of adjacent data points.

8. The method for grouting simulation and pre-control decision-making based on cross-scale data federation according to claim 7, wherein the spatial alignment comprises:
determining data points of experimental or simulation data:
(x₁, y₁, z₁), (x₂, y₂, z₂), . . . , (xₙ, yₙ, zₙ);
wherein, (xᵢ, yᵢ) is a spatial position, and zᵢ is a value corresponding to the spatial position (xᵢ, yᵢ);
calculating a distance dᵢ between a target point and a known data point:
dᵢ=\sqrt{(x₀−xᵢ)²+(y₀−yᵢ)²};
wherein, x₀, y₀ represents coordinates of the target point, and xᵢ, yᵢ represents coordinates of the known point i;
calculating a weight of each known data point using an inverse distance weighting method, a weight wᵢ being inversely proportional to a distance d(x, xᵢ) between a target point x and a data
$${w}_{i} = \frac{1}{{d}_{i}^{p}} ;$$
wherein, wᵢ represents the weight of the known point i to the target point, and p represents a weight exponent; and
calculating an estimated value z₀ of the target point (x₀, y₀) by weighted averaging:
$${Z}_{0} = \frac{{\sum }_{i = 1}^{n} {w}_{i} {z}_{i}}{{\sum }_{i = 1}^{n} {w}_{i}} ;$$
wherein, z₀ represents the estimated value of the target point (x₀, y₀), wᵢ represents the weight of the known point i, zᵢ represents a data value of the known point i, and the alignment of the entire spatial data is realized according to the estimated value z₀ of an interpolation result.

9. A system for grouting simulation and pre-control decision-making based on cross-scale data federation, comprising:
a training module, configured to: construct a knowledge graph based on grouting test data and simulation data of laboratory grouting tests, and corresponding working condition data, and train the graph convolutional neural network using node and edge information of the knowledge graph as input values of the graph convolutional neural network and using known grouting parameters as output values of the graph convolutional neural network to obtain a trained graph convolutional neural network;
a construction module, configured to: construct a geological attribute model of a target tunnel based on geological conditions of the target tunnel; and
a prediction module, configured to: obtain engineering construction monitoring data of the target tunnel, perform spatiotemporal alignment between the engineering construction monitoring data of the target tunnel and the geological attribute model of the target tunnel, input the aligned data into the trained graph convolutional neural network to obtain grouting prediction data, and adjust a grouting scheme according to the grouting prediction data until grouting construction is completed, wherein
constructing the knowledge graph based on the grouting test data and simulation data of the laboratory grouting tests, and the corresponding working condition data comprises:
obtaining the grouting test data of the laboratory grouting tests, the simulation data, and the corresponding working condition data, and standardizing all obtained parameters;
calculating a covariance matrix between the parameters, and calculating eigenvalues and eigenvectors of the covariance matrix;
sorting all the eigenvalues in descending order, selecting the eigenvectors corresponding to the top k eigenvalues as principal components, and calculating a principal component score matrix based on the principal components;
defining both original parameters and the principal components as nodes of the knowledge graph, calculating correlation coefficients between the nodes, and if the correlation coefficients are greater than a set threshold, determining that a connecting edge is provided between the nodes, or otherwise, determining that no connecting edge is present between the nodes, wherein the correlation coefficients between the nodes comprise: correlation coefficients between original parameter nodes and correlation coefficients between principal component nodes;
calculating a factor loading matrix between the original parameter nodes and the principal component nodes, and determining, if a factor loading value of an original parameter node on a principal component node is greater than a set threshold, that a connecting edge is provided between the original parameter node and the principal component node, wherein a weight of the connecting edge is an absolute value of the factor loading value; and
supplementing attributes of the original parameter nodes, and supplementing attributes of the principal component nodes, to obtain the knowledge graph.
